(19) United States
(12) Patent Application Publication
(10) Pub. No.: US 2009/0150786 A1
(43) Pub. Date: Jun. 11, 2009

(54) Media content tagging on a social network

(76) Inventor: Stephen J. Brown, Woodside, CA (US)

Correspondence Address: LUMEN PATENT FIRM, 2345 YALE STREET, SECOND FLOOR, PALO ALTO, CA, 94306, US

(21) Appl. No.: 12/001,229

(22) Filed: Dec. 10, 2007

(51) Int. Cl. G06F 3/00

(52) U.S. Cl. 715/733

(57) ABSTRACT

Tagging media content based on ratings by users of a computer implemented social network and recommending the tagged media content are provided. Content modules containing audio, video, or audio-video content are accessible to users of a social network. Each user of the social network has an updatable user profile with one or more user attributes to characterize the current state of the user. The users can rate the content modules with ratings related to the user attributes. Characterization of a content module is accomplished by the accumulation of user ratings for the content module and assigning one or more tags to the content module. The tags are also related to the user attributes. The content module tags and user attributes are used to recommend one or more content modules to the user. Content module rankings based on the tags and user attributes are also provided.

### FIELD OF THE INVENTION

The invention relates generally to media tagging. More particularly, the present invention relates to recommending media based on tags assigned by user ratings on a social network.

### BACKGROUND

Analyzing media content for determining the value and relevance of the content can be a daunting task. The analysis and determination of the content can be used for a variety of purposes, including cataloguing, searching, organizing, and, particularly, matching a specific data object to an individual. To match the data object with the individual, both the data object and the individual must be accurately characterized.

Characterization of media content is often accomplished by the assignment of one or more keywords to the data object. Standard methods exist for characterizing text data, such as by the use of statistical information about the language in which the text is written. However, for data objects containing pictures, audio, video, or audio-video data, characterizing the data object is much more difficult. Oftentimes a person, such as the creator or distributor of the data object, assigns the keywords to the data object. The assignor of the keywords, however, may not be in the best position to determine the usefulness or accuracy of the keywords. Today, due to the large amount and ubiquity of audio-video data objects and the strong desire to succinctly characterize the data, there is a need to accurately assign keywords to the data objects.

Characterization of an individual is often accomplished by an analysis of the past actions of the individual. The historical analysis can include items purchased by the individual, data the individual downloaded, websites visited by the individual, etc. The analysis can be used to direct potential items or services that may be of interest to the individual. These past actions, however, may not accurately characterize the current state or need of the individual. In addition, the accumulation of many past actions may increase the difficulty for the characterization means to identify current needs of the individual if the current needs differ from the past actions of the individual. The dependence on an accumulation of past actions limits the individual's ability to control his or her own characterization.

Social networking websites, such as Facebook.com and MySpace.com, maintain personal profiles for the members of the social networks. The personal profiles enable members to post and update their personal information. Members are also generally able to communicate with other members, join common interest communities, and post and view media data objects, including photographs, audio clips, and video clips. Members generally do not have a method to evaluate the content of the data objects and must rely solely on the titles of the data objects to determine if the data objects should be viewed.

Matching a specific data object to an individual is particularly important when the data object is for self-improvement of the individual, such as for weight loss or fitness. Websites, such as WeightWatchers.com and eDiets.com, provide expert advice and tips for helping members to accomplish their diet and health goals. The advice and tips, however, are generally directed to the members in a fixed sequential format or simply based on the current date. The members generally do not receive health tips based on the current state of the members.

The present invention addresses the difficult problem of characterizing and recommending appropriate media content. The present invention advances the art with media tagging based on ratings of the media content by users of a social network.

### SUMMARY OF THE INVENTION

The present invention is directed to tagging and recommending media content to a user of a computer implemented social network based on ratings of the media content by users of the social network. An application server operates the social network and maintains a user profile for each user of the social network. The user profile includes one or more user attributes for describing the current status of the user, such as the user's current need and/or psychological state. Media content in the form of content modules are accessible and viewable by the users of the social network. A function is provided for the users of the social network to rate the media content, where the ratings are related to the user attributes. The accumulation of ratings for each of the content modules is used to assign one or more tags to the content module. Similar to the ratings, the assigned tags are related to the user attributes. A content module is recommended to a user based on the assigned tags of the content module and the current user attributes of the user.

Users of a social network for personal behavioral modification, such as health, weight loss, or fitness, would particularly benefit from the present invention. In a social network for personal behavioral modification, the content modules can include coaching content and user attributes can include at least one behavioral action, at least one emotional state, or both. The content modules can be stored in any number of databases and can be in any format, including text, picture, audio, video, audio-video, or any combination thereof. The user attributes are updatable by the user and allow the user to accurately describe the current state and need of the user. Similarly, the assigned tags of a particular content module are changeable due to changes in user ratings of the content module.

Optional aspects of the current invention include ranking the recommended content modules for a user, posting a description for each of the content modules, and tracking the view history of the user. The view history of the user can be used to ensure that the user receiving the recommendation has not previously viewed the recommended content module. The present invention enables a user of a computer implemented social network to receive recommended media content based on the current state of the user and assigned tags of the media content as determined by user ratings.

### BRIEF DESCRIPTION OF THE FIGURES

The present invention together with its objectives and advantages will be understood by reading the following description in conjunction with the drawings, in which:

FIG. 1 shows an example of recommending a content module C2 to user A based on user attributes 150 of user A and the assigned tags 145 of the content modules according to the present invention.

FIG. 2 shows an example of a user profile with user attributes and a recommended video according to the present invention.

FIG. 3 shows an example of a video-rating interface according to the present invention.

FIG. 4 shows an example of users U rating a video C and an assignment of a tag based on the ratings according to the present invention.

FIG. 5 shows an example of an interface showing ranked videos according to the present invention.

### DETAILED DESCRIPTION OF THE INVENTION

Analyzing media content, especially video content, is a difficult task. Oftentimes, even the creator or distributor of the media content cannot determine the situations in which the media content would be most effective for a potential viewer. Finding effective content is particularly relevant when the media content is coaching content for personal behavioral modification. Below is a detailed description of media tagging on a social network for recommending the appropriate media content to a potential viewer.

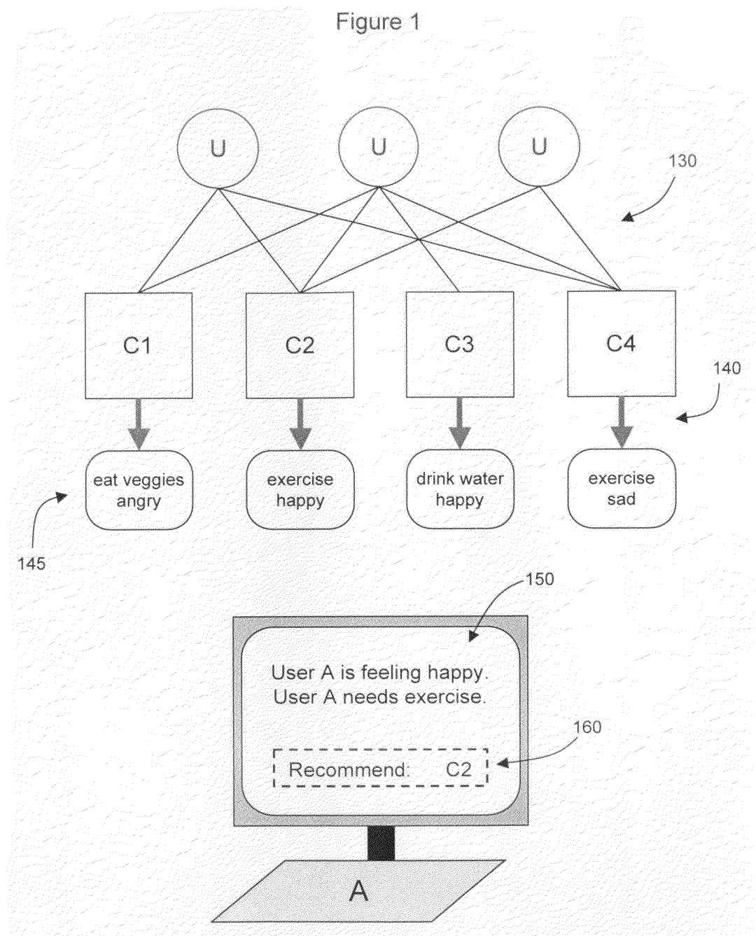

FIG. 1 shows an example of content tagging and recommending on a computer implemented social network. Content modules C1, C2, C3 and C4 are accessible by users U of the social network. Each user of the social network has a user profile that includes one or more user attributes 150. The users U of the social network are also allowed to rate the content modules. The rating is related to the user attributes 150. In FIG. 1, users U rate 130 content modules C1, C2, C3 and C4 preferably after they have viewed the content modules. The ratings 130 are used to assign 140 tags 145 to each of the rated content modules. Like the ratings 130, the tags 145 are also related to the user attributes 150. The relation between the tags 145 and the user attributes 150 is the basis for recommending 160 a particular content module to a user. For the example shown in FIG. 1, since the user attributes 150 of user A indicate that the user needs exercise and is feeling happy, content module C2 with tags “exercise” and “happy” is recommended to user A.

In a preferred embodiment, the computer implemented social network is for personal behavioral modification or self-improvement, such as weight loss or fitness. An application server operates the social network and users access the social network through a computer network, such as the Internet. The access can be through a web browser on a personal computer, or any other computing means, such as a mobile phone and a personal digital assistant.

The content modules can have any format, including pictures, audio, video, audio-video, text, or any combination thereof. For a social network for personal behavioral modification, the content modules preferably include coaching content for assisting users to modify their personal behavior. However, the content modules can include content to serve other functions, such as entertainment and information. A distributor or creator of a content module can be anyone, including a user of the social network, an expert, a coach, a health care professional, a nutritionist, and a personal trainer. The content modules can be provided with or without payment. The content modules can be stored by one or more databases communicatively connected to the application server and/or content module providers can store the content modules locally.

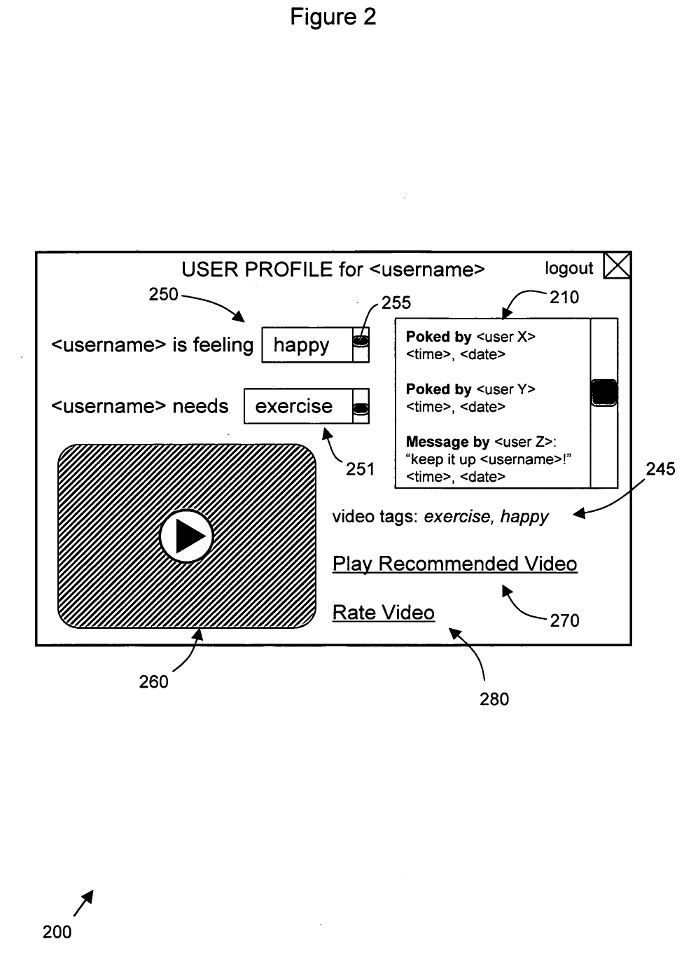

FIG. 2 shows a user profile 200 that includes user attributes 250 and 251. In a preferred embodiment, at least one user attribute is related to a behavioral action 251 of the user, an emotional/psychological state 250 of the user, or both. For a social network for weight loss, behavioral actions 251 can include, but are not limited to physical exercise, consumption of fruits and vegetables, and water consumption. A user is able to choose and update the behavioral action 251 and emotional state 250. The entry of a user attribute of the user profile 200 can be made by manual entry in a text box, a drop down menu, or any other data entry means. FIG. 2 shows a user profile 200 with a scroll bar 255 for a user to select an emotional state 250. Selections of emotional states 250 can include, but are not limited to bad, better, good, guilty, sick, sorry, well, down, alone, happy, great, sad, lost, tired, lonely, horrible, pretty, special, loved, depressed, fine, confident, big, important, complete, fat, proud, stressed, helpless, angry, ashamed, needed, scared, beautiful, hungry, satisfied, handsome, frustrated, insecure, calm, emotional, and motivated.

It is important to note that recommendations of content modules are made based on the user attributes. One or more tags 245 assigned to the recommended content module 260 are compared with the user attributes 250 and 251 to form a basis for the recommendation. The recommended content module 260 can be displayed on the user profile 200 as shown in FIG. 2 or it can be otherwise accessible by the user receiving the recommendation, such as via a link to download the module or as an attachment sent to the user. In a preferred embodiment, the recommended content module 260 is displayed as a “tip of the day” on the user profile 200. A content module containing audio, video, or audio-video content can be played 270 on the user profile 200, saved by the user, and/or sent to the user for later viewing. The user can also rate 280 the recommended content module.

A message box 210 can also be included in the user profile 200. The message box 210 displays messages sent to the user by other users of the social network. The messages can be for support and encouragement for the user, particularly if the social network is for personal behavioral modification. As one of ordinary skill in the art can appreciate, other features, such as pictures, user interests, newsfeeds, and bulletin boards, can be included in the user profile.

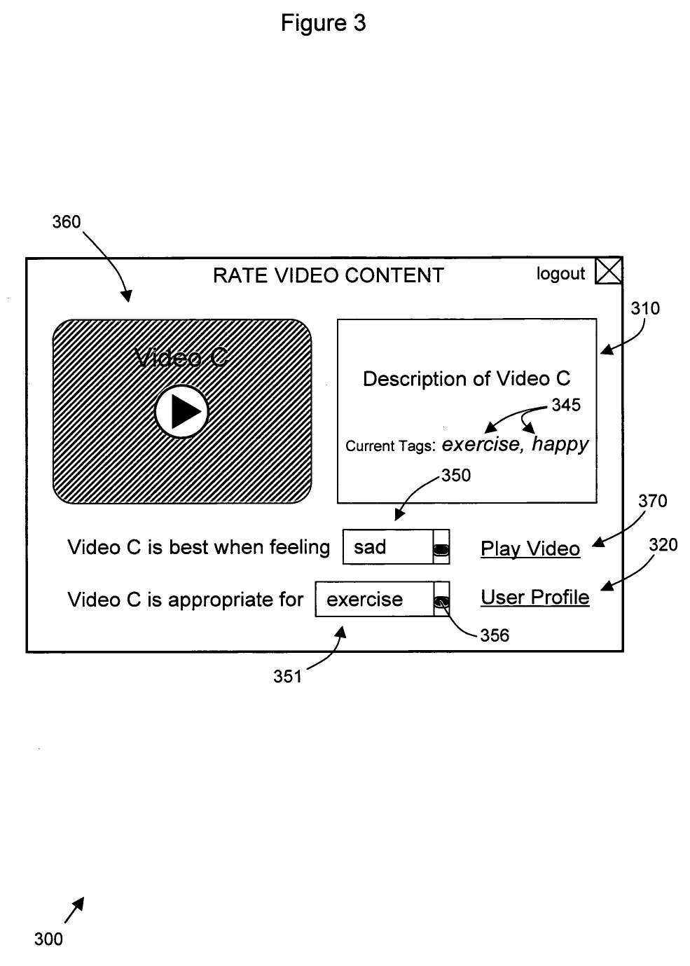

A rating function is provided for users to rate content modules. FIG. 3 shows an example of a video-rating interface 300 where a user can rate video C with ratings related to the user attributes. For example, the rating can be based on an emotional state 350 and a behavioral action 351 which correspond to the emotional state 250 and behavioral action 251 of the user, respectively, displayed on the user profile 200. Though FIG. 3 only shows a method of rating whereby the user assigns one or more attributes to the video, other rating methods can be used. An example of an alternative rating method has a user choose a value based on a scale or metric for some or every emotional state, e.g. a user enters a number from 0-9 as a measure of the appropriateness of the video for the “sad” emotional state, enters a separate number for the “proud” emotional state, and repeats the entry for other emotional states.

The relation of the ratings to the user attributes enable users to determine the appropriateness of a content module to a current state or need of the users. It is most suitable for users to rate the content modules, since the content modules are oftentimes directed at the users. An accumulation of many ratings would accurately and effectively find one or more appropriate tags for a content module.

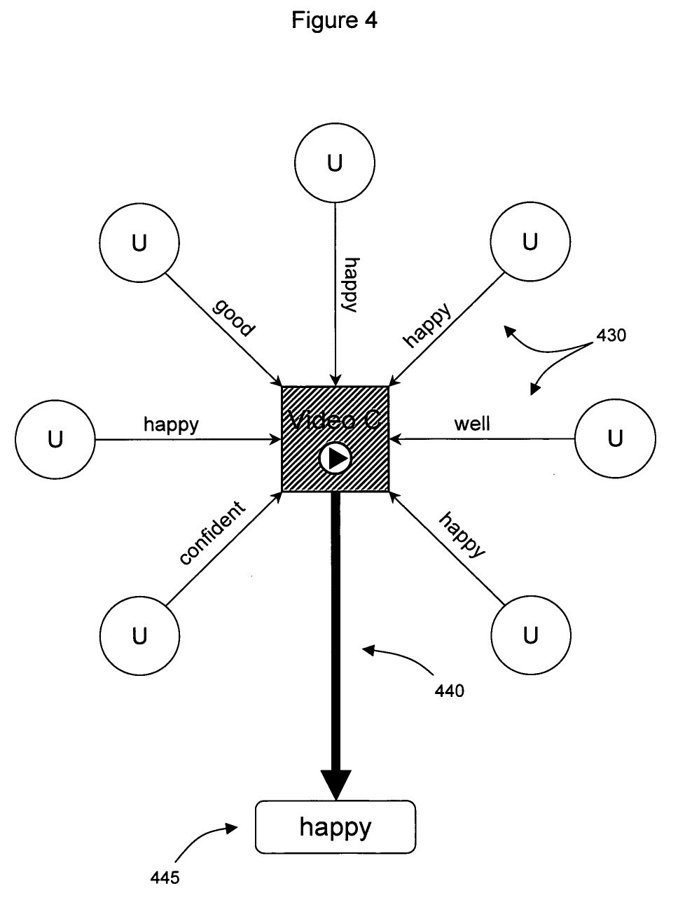

FIG. 4 shows an example of an assignment 440 of a tag 445 for video C based on an accumulation of multiple user ratings 430 of video C. A function is used for the assignment of one or a small number of tags from an accumulation of a potentially large number of ratings. The function may be a simple preponderance of a selection of a user attribute, as in the example shown in FIG. 4. The function may also be more complicated involving relationships of different attributes and selections. For ratings with numerical values, an average, weighted average, or total can be calculated for the tag assignment. Though the tag 445 and ratings 430 are related to an emotional state of the user in FIG. 4, the tag 445 and ratings 430 can generally be related to any user attribute.

It is important to note that a content module's tag is changeable due to changes in user ratings. Changes to the tag assignment could be caused by an increase in the number of user ratings as more users rate the content module (or a decrease in number if ratings are deleted), changes a user makes to his or her rating, or changes to the user attributes. The changeability of the tags creates flexibility for recommending content modules to users and allows freedom for the global social network community to determine the appropriateness and value of each content module.

It is also important to note that even if the tags of the content modules do not change, the recommendation to a particular user is changeable. Because user attributes can be updated, the appropriate content module recommended for the user can change with an update of one or more attributes. In other words, the recommendation to a single user is dynamic in time, with the recommended content module depending on the current attributes of the user.

FIG. 3 also shows a description 310 of the content module to be rated. The description can contain information about the content module and the current tags 345 assigned to the content module. A description of the recommended content module can also be displayed on the user profile 200.

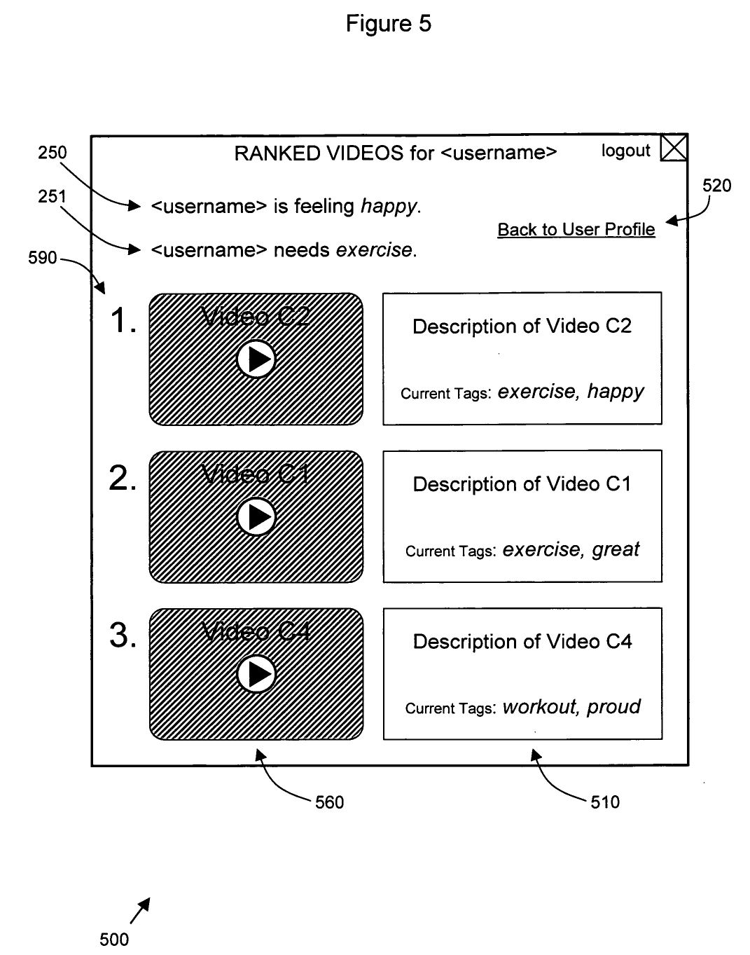

Instead of or in addition to recommending a single content module, a ranking of the available content modules could be provided to a user. FIG. 5 shows an example of an interface where videos are ranked in order of appropriateness for the user. The rankings 590 can be based on similar functions as the assignment of the tags. In other words, a measure of appropriateness based on the current user attributes can determine the order in which videos should be recommended. FIG. 5 shows a column of ranked videos 560 next to a column of their descriptions 510. The rankings 590 of the videos 560 shown in FIG. 5 are accurate because the tags of video C2, the top ranked video, directly match the user attributes 250 and 251, the tags of video C1 are closely matched to the attributes, and the tags of video C4, the third ranked video, are more loosely aligned with the user attributes.

The rankings 590 give a user more information to choose the appropriate content module. In other words, the rankings combine individual user flexibility in the selection of a content module and the appropriateness measure determined by the social network community. Though FIG. 5 only shows the three highest ranked videos, any number of content modules could be shown. A scroll bar or links may be used to access other content modules.

Another utility of the ranking is to recommend the highest ranked content module not viewed by the user. In an embodiment of the present invention, the viewing history of the user is tracked. If the viewing history indicates that a content module has been viewed, the next highest ranked content module is recommended to the user, thereby preventing repeat recommendations of the same content module to the user.

As one of ordinary skill in the art will appreciate, various changes, substitutions, and alterations could be made or otherwise implemented without departing from the principles of the present invention, e.g. the Internet could be substituted by a local area network and other user attributes not explicitly mentioned could be used for rating and tagging. Accordingly, the scope of the invention should be determined by the following claims and their legal equivalents.

What is claimed is:

1. A method for recommending content, comprising:
(a) having a computer implemented social network of a plurality of users, wherein each of said plurality of users has a user profile, and wherein said user profile comprises one or more user attributes;
(b) having a plurality of content modules, wherein said plurality of content modules are accessible by said plurality of users of said social network;
(c) providing a rating function for allowing said plurality of users of said social network to rate at least one of said plurality of content modules, wherein said rating is related to said one or more user attributes;
(d) accumulating said ratings of each of said plurality of content modules to assign a tag to the same of said plurality of content modules, wherein said assigned tag is related to said one or more user attributes; and
(e) recommending one of said plurality of content modules to one of said plurality of users of said social network, wherein said recommendation is based on said tag of each of said plurality of content modules and said one or more user attributes of the same of said plurality of users.

2. The method as set forth in claim 1, wherein said one or more user attributes comprises:
(a) at least one behavioral action;
(b) at least one emotional state; or
(c) at least one behavioral action and at least one emotional state.

3. The method as set forth in claim 1, wherein said user profile of each of said plurality of users of said social network is updatable, and wherein said recommendation changes based on said update.

4. The method as set forth in claim 1, further comprising ranking said plurality of content modules, wherein said ranking is based on said tag of each of said plurality of content modules and said one or more user attributes of said user receiving said recommendation, and wherein said recommendation is based on said ranking.

5. The method as set forth in claim 1, wherein said recommended content module has not been previously viewed by said user receiving said recommendation.

6. The method as set forth in claim 1, wherein said computer implemented social network is for a personal behavioral change.

7. The method as set forth in claim 6, wherein at least one of said plurality of content modules comprises coaching content for said personal behavioral change.

8. The method as set forth in claim 1, wherein at least one of said plurality of content modules comprises audio, video, or audio-video content.

9. The method as set forth in claim 1, further comprising displaying a description for at least one of said plurality of content modules, wherein said description includes said assigned tag of said at least one of said plurality of content modules.

10. A system for recommending content, comprising:
(a) an application server for operating a computer implemented social network of a plurality of users, wherein said application server hosts a user profile for each of said plurality of users of said social network, and wherein said user profile comprises one or more user attributes;
(b) a database for storing a plurality of content modules, wherein said plurality of content modules are accessible by said plurality of users of said social network;
(c) a rating function for allowing said plurality of users of said social network to rate at least one of said plurality of content modules, wherein said rating is related to said one or more user attributes;
(d) a tagging function for assigning a tag to each of said plurality of content modules from an accumulation of said ratings of the same of said plurality of content modules, wherein said assigned tag is related to said one or more user attributes; and
(e) a recommendation function for recommending one of said plurality of content modules to one of said plurality of users, wherein said recommendation is based on said tag of each of said plurality of content modules and said one or more user attributes of the same of said plurality of users.

11. The method as set forth in claim 10, wherein said one or more user attributes comprises:
(a) at least one behavioral action;
(b) at least one emotional state; or
(c) at least one behavioral action and at least one emotional state.

12. The system as set forth in claim 10, wherein said user profile of each of said plurality of users of said social network is updatable, and wherein said recommendation changes based on said update.

13. The system as set forth in claim 10, further comprising a ranking function for ranking said plurality of content modules, wherein said ranking is based on said tag of each of said plurality of content modules and said one or more user attributes of said user receiving said recommendation, and wherein said recommendation is based on said ranking.

14. The system as set forth in claim 10, wherein said recommended content module has not been previously viewed by said user receiving said recommendation.

15. The system as set forth in claim 10, wherein said computer implemented social network is for a personal behavioral change.

16. The system as set forth in claim 15, wherein at least one of said plurality of content modules comprises coaching content for said personal behavioral change.

17. The system as set forth in claim 10, wherein at least one of said plurality of content modules comprises audio, video, or audio-video content.

18. The system as set forth in claim 10, further comprising a description for at least one of said plurality of content modules, wherein said description includes said assigned tag of said at least one of said plurality of content modules.
